(19) United States
(12) Patent Application Publication
(10) Pub. No.: US 2026/0147546 A1
(43) Pub. Date: May 28, 2026

(54) AUTOMATED CODEBASE DEPRECATION FOR REDUCING SYSTEM VULNERABILITY

(71) Applicant: MICROSOFT TECHNOLOGY LICENSING, LLC, Redmond, WA (US)

(72) Inventors: Nidhi VERMA, Bellevue, WA (US); Nicola Greene ALFEO, Seattle, WA (US)

(21) Appl. No.: 18/962,187

(22) Filed: Nov. 27, 2024

(51) Int. Cl. G06F 8/35; G06F 8/65

(52) U.S. Cl. CPC G06F 8/35; G06F 8/65

(57) ABSTRACT

The techniques disclosed herein provide a system for automated deprecation of software codebases using a self-training analysis agent and a weighted input representing a plurality of codebase factors. Generally speaking, operating a cloud computing platform is complex and can involve managing a large number of software codebases including source code, infrastructure, configuration, and user applications. Consequently, as new products and/or services are released, technology advances, and various software codebases age, portions of the cloud computing platform may become vulnerable to errors, malicious actors, and other undesirable behaviors that lead to degraded service quality. The system presented herein utilizes a self-training analysis agent to automatically identify a given software codebase for deprecation using a weighted input representing a plurality of factors relating to the codebase such as code type, a code age, and usage metrics. Accordingly, the codebase is archived for a predefined time period prior to final deprecation.

### BACKGROUND

With the ever-growing ubiquity of cloud computing, more and more data and/or services are stored and/or provided online via network connections. Providing an optimal and reliable user experience is an important aspect for cloud computing platforms that offer network services. In many scenarios, a cloud computing platform may provide a service to thousands or millions of users (e.g., customers, clients, tenants, etc.) geographically dispersed around a country, or even the world. In order to provide this service, a cloud computing platform often includes different resources, such as server farms, hosted in various datacenters. These resources can be constructed using various resource units which include low-level infrastructure objects such as virtual machines, physical machines, network devices, and containers. In addition, the service can be constructed of various software codebases such as source code, configuration files, user applications, deployment infrastructure, and the like.

Moreover, large-scale cloud computing platforms can include several cloud services comprising their own architecture of software codebases as well as hosting user-generated software codebases. As such, operating a large-scale cloud computing platform can involve managing millions of individual software codebases across different cloud computing services belonging to different teams, engineers, users, and so on. Consequently, as new products and/or services are released, technology advances, and various software codebases age, portions of the cloud computing platform may become vulnerable to errors, malicious actors, and/or other undesirable behaviors that lead to degraded service quality. It is with respect to these and other considerations that the disclosure made herein is presented.

### SUMMARY

The techniques presented herein provide a system for automated deprecation of software codebases using a self-training analysis agent and/or a weighted input representing a plurality of codebase factors. As mentioned above, operating a cloud computing platform is complex and can involve managing a large number of software codebases including source code, infrastructure, configuration, and user applications. Consequently, as new products and/or services are released, technology advances, and various software codebases age, portions of the cloud computing platform may become vulnerable to errors, malicious actors, and other undesirable behaviors that lead to degraded service quality. This is especially true for large-scale cloud computing platforms which oftentimes (1) are high-profile targets for unscrupulous behavior and (2) include a large number of software codebases that represent a greater opportunity for failures and/or exploitation as various software codebases age and/or go unaccounted-for.

In a specific example, consider a scenario in which a cloud computing platform utilizes an internal software codebase to evaluate features of a cloud computing service and/or collect diagnostic data prior to release using a test user account. Accordingly, the test user account is provisioned with elevated permissions to enable access to all levels and/or functionalities of the cloud computing service. However, as the features and/or infrastructure of the cloud computing service changes over time, the internal test user account may gradually fall out of use. Nonetheless, the internal test user account still retains its elevated permissions. In the event this internal software codebase is compromised, the attacker can gain access to critical infrastructure and/or information. Conversely, had the internal software codebase been detected and properly updated and/or deprecated, the associated vulnerability would be eliminated.

However, many existing systems lack tools for updating and/or deprecating software codebases. That is, the process of detecting and deprecating code is a largely manual process. In various examples, an engineer surmises that a given software codebase is a likely candidate for deprecation and then collects relevant data such as telemetry, log files, and the like. From the data, the engineer can determine whether the software codebase warrants deprecation and proceed to manually remove the software codebase. Deprecating software codebases in this way requires a significant amount of manual labor and expertise which is oftentimes infeasible as large-scale cloud computing platforms already employ hundreds or even thousands of skilled engineers. In addition, manual deprecation can be error prone as well. For instance, an engineer may incorrectly determine that a software codebase is no longer in use and deprecate it to the chagrin of colleagues and/or customers that were using the software codebase. In another example, the engineer may not realize other codebases may have been depending on the deprecated codebase leading to errors and potentially service downtime.

In contrast, the present system utilizes a self-training analysis agent to automatically identify and deprecate software codebases. Generally described, the analysis agent begins by retrieving a weighted input associated with a given software codebase. In various examples, the weighted input represents a variety of factors that can influence whether a given software codebase is a good candidate for deprecation such as code type (e.g., source code, configuration file, infrastructure), code age, usage metrics, dependencies on and/or from other software codebases, and so forth. Accordingly, the various factors are weighted to emphasize certain factors and deemphasize other factors based on the specific operational context of the software codebase. For example, a newly deployed software codebase can be weighted to emphasize code age while deemphasizing usage as it would not make sense to deprecate a newly deployed software codebase due to low usage.

Accordingly, the analysis agent can identify a given software codebase as a candidate for deprecation based on the plurality of factors represented by the associated weighted input. In various examples, the factors are analyzed by the analysis agent to determine an aggregate deprecation score that quantifies the risk posed by deprecating a given software codebase (e.g., a risk of service downtime, a risk of errors). In a specific example, a higher deprecation score indicates greater risk. Consequently, if the deprecation score is less than a threshold deprecation score, the associated software codebase is a good candidate for deprecation. Stated another way, if the risk of deprecating the software codebase is less than a maximum acceptable risk defined by the threshold deprecation score, the software codebase is a good candidate for deprecation.

In response to identifying the software codebase as a candidate for deprecation, the analysis agent deploys a change to the software codebase to begin the deprecation process. Generally described, the change is a piece of software that removes the software codebase from active usage and archives the software codebase in preparation for final deprecation. Moreover, the type of the change is customized to the code type of the software codebase. For instance, a software codebase for source code requires a different change from a software codebase for configuration files. In addition, archiving the software codebase prior to deprecation enables the deprecation system to (1) comply with data retention policies and/or regulations and (2) revive the software codebase if needed.

Once the software codebase has been archived for a predefined time period (e.g., six months, seven years), the software codebase is now eligible for final deprecation. Accordingly, the deprecation system generates a recommendation review (e.g., a pull request) to request final approval for deprecating the software codebase. As such, the recommendation review is sent to an entity that is responsible for the software codebase. In various examples, this responsible entity is an engineer and/or a team of engineers that manages (e.g., “owns”) the software codebase. In another example, the responsible entity is an automated codebase management tool. Upon approval by the responsible entity, the software codebase is fully removed, completing the deprecation process.

In one example of the technical benefit of the present disclosure, using a self-training analysis agent to identify software codebases for deprecation improves the quality of cloud computing services. By periodically identifying and deprecating outdated and/or otherwise unused software codebases, the deprecation system mitigates the risk of errors stemming from such software codebases thereby preventing service downtime. In a conventional system without tools for automated deprecation, an engineer would need to manually identify and deprecate software codebases. The effect of a manual approach is twofold. First, engineers must split their efforts between deprecating software codebases, developing new features, and/or addressing bugs. Secondly, when presented with this dilemma in practice, the intense labor required to identify and deprecate software codebases is infeasible even for organizations that employ hundreds and even thousands of skilled engineers. Consequently, outdated and/or error-prone software codebases can often go undetected until an issue occurs. In contrast, the deprecation system presented herein enables cloud computing platform operators to be proactive in their codebase management thereby improving service quality by reducing downtime.

In another example of the technical benefit of the present disclosure, proactive codebase management enabled by automated deprecation improves the security of cloud computing platforms. As mentioned above, a failure to identify and deprecate software codebases can result in service downtime. In some examples, service downtime is the result of a malicious actor (e.g., foreign agents, domestic criminals) exploiting vulnerabilities exposed by outdated and/or error prone software codebases. As such, proactively identifying and deprecating software codebases mitigates such vulnerabilities, often referred to as an attack surface. Stated another way, automated software codebase deprecation minimizes the total number of entry points that can allow an unauthorized user to access and/or exfiltrate data within a given system thereby enhancing platform security.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system for automated identification and deprecation of software codebases.

FIG. 2 is a diagram of a weighted input representing a plurality of factors that are each weighted according to an operational context of an associated software codebase.

FIG. 3A illustrates a first example of applying weights to emphasize and/or deemphasize various factors of the weighted input.

FIG. 3B illustrates a second example of applying weights to emphasize and/or deemphasize various factors of the weighted input.

FIG. 4 illustrates an example user interface of a recommendation review for final approval prior to deprecating a software codebase.

FIG. 5 is a flow diagram showing aspects of a process for automated software codebase deprecation using an analysis agent.

FIG. 6 is a computer architecture diagram illustrating an illustrative computer hardware and software architecture for a computing system capable of implementing aspects of the techniques and technologies presented herein.

FIG. 7 is a diagram illustrating a distributed computing environment capable of implementing aspects of the techniques and technologies presented herein.

### DETAILED DESCRIPTION

The techniques presented herein provide a system for automated deprecation of software codebases using a self-training analysis agent and/or a weighted input representing a plurality of codebase factors. As mentioned above, operating a cloud computing platform is complex and can involve managing a large number of software codebases including source code, infrastructure, configuration, and user applications. Consequently, as new products and/or services are released, technology advances, and various software codebases age, portions of the cloud computing platform may become vulnerable to errors, malicious actors, and other undesirable behaviors that lead to degraded service quality. This is especially true for large-scale cloud computing platforms which oftentimes (1) are high-profile targets for unscrupulous behavior and (2) include a large number of software codebases that represent an elevated risk for failures and/or exploitation as various software codebases age and go unaccounted-for.

In a specific example, consider a scenario in which a cloud computing platform utilizes an internal software codebase to evaluate features of a cloud computing service and/or collect diagnostic data prior to release using a test user account. Accordingly, the test user account is provisioned with elevated permissions to enable access to all levels and/or functionalities of the cloud computing service. However, as the features and/or infrastructure of the cloud computing service changes over time, the internal test user account may gradually fall out of use. Nonetheless, the internal test user account still retains its elevated permissions. In the event this internal software codebase is compromised, the attacker can gain access to critical infrastructure and/or information. Conversely, had the internal software codebase been detected and properly updated and/or deprecated, the associated vulnerability would be eliminated. As such, the deprecation system presented herein assist cloud computing platform operators (e.g., engineers, technicians) by identifying and deprecating eligible software codebases.

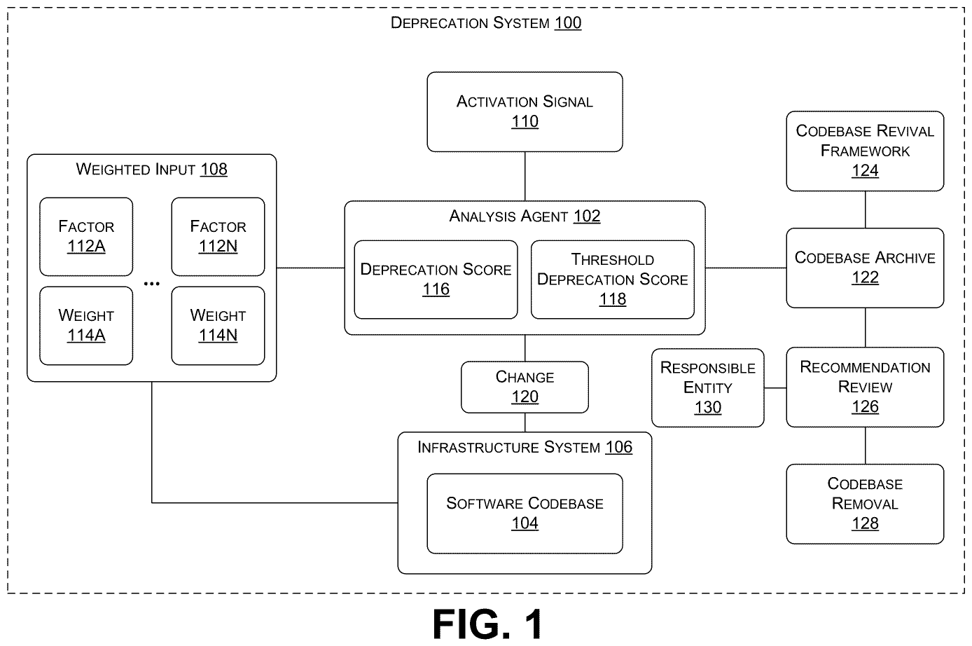

Various examples, scenarios, and aspects related to the techniques are described below with respect to FIGS. 1-7.

FIG. 1 illustrates a deprecation system 100 that utilizes a self-training analysis agent 102 that identifies a software codebase 104 for deprecation based on a weighted input associated with the software codebase 104. Generally described, a software codebase 104 is an individually identifiable collection of at least one computer code file that is compiled to build a software application, component, or system. In addition, the analysis agent 102 is a computational model implementing an artificial intelligence such as a language model that is configured to identify software codebases for deprecation based on associated weighted inputs. As such, the analysis agent 102 is initially trained on a training dataset prior to deployment in the deprecation system 100. Moreover, the analysis agent can continue to learn during deployment based on the various software codebases 104 and associated weighted inputs it encounters during normal operation.

As shown, the software codebase 104 is managed by an infrastructure system 106 in which the analysis agent 102 is integrated. That is, the analysis agent 102 is extensible to many infrastructure systems 106 to provide support for any type of software codebase 104. Accordingly, the analysis agent 102 retrieves a weighted input 108 associated with the software codebase 104 in response to an activation signal 110. Generally described, the activation signal 110 is any input that triggers the analysis agent 102 to retrieve and analyze weighted inputs 108 for various software codebases 104. In various examples, the activation signal 110 is a manual trigger that is an explicit command from a user to begin identifying software codebases 104 for potential deprecation. In another example, the activation signal 110 is an automated trigger that is configured to cause the analysis agent 102 to perform its analysis at regular intervals (e.g., once per day, once per week). In still another example, the activation signal is an automated trigger that is not periodic. For instance, the activation signal 110 can be generated in response to an alert at the infrastructure system 106 in response to an issue that requires an emergency deprecation (e.g., an elevated error rate).

As shown in FIG. 1, the weighted input 108 incorporates a plurality of factors 112A-112N that describe various aspects of the software codebase 104. In a specific example, one factor 112A specifies a code type of the software codebase 104 (e.g., application source code, configuration settings code, deployment infrastructure code) while another factor 112N specifies the age of the code within the software codebase (e.g., six months, ten years). Additional examples of the factors 112A-112N will be described below.

In addition, each of the factors 112A-112N is assigned an associated weight 114A-114N that emphasizes or deemphasizes the influence of the associated factor 112A-112N on the weighted input 108. For instance, consider again a code type factor 112A in which the software codebase 104 is deployment infrastructure code and a code age factor 112N in which the software codebase 104 is three months old. As such, the weight 114A can be applied to the code type factor 112A to emphasize that deployment infrastructure code should be maintained more aggressively due to the potential for attack. Conversely, the weight 114N can be applied to the code age factor 112N to deemphasize the importance of code age in the present example as it is unlikely a newly deployed software codebase 104 needs to be deprecated due to outdated and/or legacy code.

In various examples, the number and/or type of the factors 112A-112N as well as the corresponding weights 114A-114N (as represented by “N”) are configurable by an operator (e.g., an engineer, a technician) to suit various technical needs. For example, consider a scenario in which the analysis agent 102 processes a first software codebase 104 and a second software codebase that are managed by the same infrastructure system 106. Accordingly, the first software codebase 104 is associated with a first weighted input 108 while and the second software codebase is associated a second weighted input. Consequently, the analysis agent 102 can apply a first weighting 114A-114N to the factors 112A-112N of the first weighted input 108 and a second weighting to the factors of the second weighted input.

As such, the analysis agent 102 is configured to self-train as factors 112A-112N and/or weights 114A-114N change across different software codebases 104 and/or different infrastructure systems 106. Moreover, the analysis agent 102 may be further configured to self-train based on changes within a given software codebase 104 and/or infrastructure system 106. For example, the analysis agent 102 can utilize metrics derived from the software codebase 104 and/or other codebases to detect trends in various factors 112A-112N such as a tendency to increase emphasis on a code age factor 112A as a software codebase 104 ages. In this way, the analysis agent 102 can iteratively adjust its calculation of the deprecation score 116 and improve its accuracy in identifying software codebases 104 that are eligible for deprecation as well as adapt to different types of software codebases 104 over time. In various examples, the analysis agent 102 is a computational model that is configured for use with respect to artificial intelligence and/or machine learning. For instance, the computational model can implement any one of a language model (e.g., a large language model), a neural network (e.g., convolutional neural networks, recurrent neural networks such as Long Short-Term Memory), a Gated Adaptive Network for Deep Automated Learning of Features, a Naïve Bayes model, a k-nearest neighbor algorithm, a majority classifier, a support vector machines, a random forest, a boosted tree, a Classification and Regression Tree (CART), and so on.

Accordingly, the analysis agent 102 aggregates the factors 112A-112N of the weighted input 108 to calculate a deprecation score 116 that quantifies the risk posed by deprecating the software codebase 104. In various examples, a higher deprecation score 116 indicates a greater risk in relation to a lower deprecation score 116. For example, a software codebase 104 that is depended on by several other codebases poses a significant risk of system failures if the software codebase 104 is deprecated. The extensive dependency of the software codebase 104 is accordingly captured in the weighted input 108 as one of the factors 112A and its associated weight 114A. Consequently, the analysis agent 102 calculates a higher deprecation score 116 relative to a different software codebase that does not involve as intricate a dependency chain. The analysis agent 102 then compares the deprecation score 116 against a threshold deprecation score 118. Generally described, the threshold deprecation score 118 defines a maximum acceptable risk for deprecating a software codebase 104. As such, if the deprecation score 116 for the software codebase 104 is less than or equal to the threshold deprecation score 118, the analysis agent 102 identifies the software codebase 104 as a candidate for deprecation.

In response, the analysis agent 102 begins the deprecation process for the software codebase 104 by deploying a change 120 to the software codebase 104 to remove the software codebase 104 from active usage. In various examples, the change 120 is a software update that causes the infrastructure system 106 to remove the software codebase 104 from active usage. That is, the software codebase 104 is no longer active nor accessible to users and/or operators. As such, the change 120 is customized to the operational context of the software codebase 104 and its associated infrastructure system 106. For example, a software codebase 104 for application source code may require a different change 120 for archiving in relation to a different codebase for deployment infrastructure code. Accordingly, the change type of the change 120 can be configured based on the factors 112A-112N of the weighted input 108.

In various examples, the change 120 can be subject to approval from a responsible entity 130 of the software codebase 104 prior to deployment. In a specific example, the analysis agent 102 generates a pull request with the change 120 for review by the responsible entity 130 for approval (e.g., an engineer, a development team, an automated codebase management tool). In this way, the analysis agent 102 can ensure a pending change 120 to remove a software codebase 104 from active usage is appropriate and/or correct prior to deploying the change 120.

In addition, the change 120 places the software codebase 104 in a codebase archive 122 (e.g., “cold storage”) for a predefined time period prior to final deprecation (e.g., six months, seven years). In this way, should the software codebase 104 be needed, the deprecation system 100 can retrieve the software codebase 104 using a codebase revival framework 124. Generally described, the codebase revival framework 124 is a mechanism for retrieving a software codebase 104 from the codebase archive 122 and restoring the software codebase 104 to active usage. In a specific example, the analysis agent 102 archives a software codebase 104 for accessing and/or managing tax data for a given calendar year. In this example, the tax data is no longer needed in normal usage but is nonetheless stored in the codebase archive 122 to comply with a data retention policy and/or local regulations. In the event the tax data is needed (e.g., an audit), the deprecation system 100 utilizes the codebase revival framework 124 to retrieve the software codebase 104 to revive the tax data as well as any code required to access and/or manage the tax data. In another example, the codebase revival framework 124 enables the restoration of a software codebase 104 in the event of erroneous deprecation. For instance, the analysis agent 102 may deploy a change 120 that removes the software codebase 104 from active usage with the approval of a responsible entity 130. However, the responsible entity 130 may realize that approving the automated deprecation change 120 was a mistake. Accordingly, the codebase revival framework 124 is invoked to restore the software codebase 104 prior to final deprecation.

Once the predefined time period has elapsed, the deprecation system 100 then generates a recommendation review 126 requesting approval for final removal 128 of the software codebase 104. As mentioned above, the recommendation review 126 is provided to a responsible entity 130 f the software codebase 104 (e.g., an “owner” of the software codebase 104). In a specific example, the responsible entity 130 is an engineer and/or a team of engineers that developed and/or oversees the software codebase 104. As such, the responsible entity 130 can provide human expertise in determining whether to deprecate the software codebase 104 thereby further minimizing the risk of incorrect deprecations. In another example, the responsible entity 130 is an automated codebase management tool (e.g., an artificial intelligence) that is configured with knowledge of the software codebase 104 and can automatically approve the recommendation review 126.

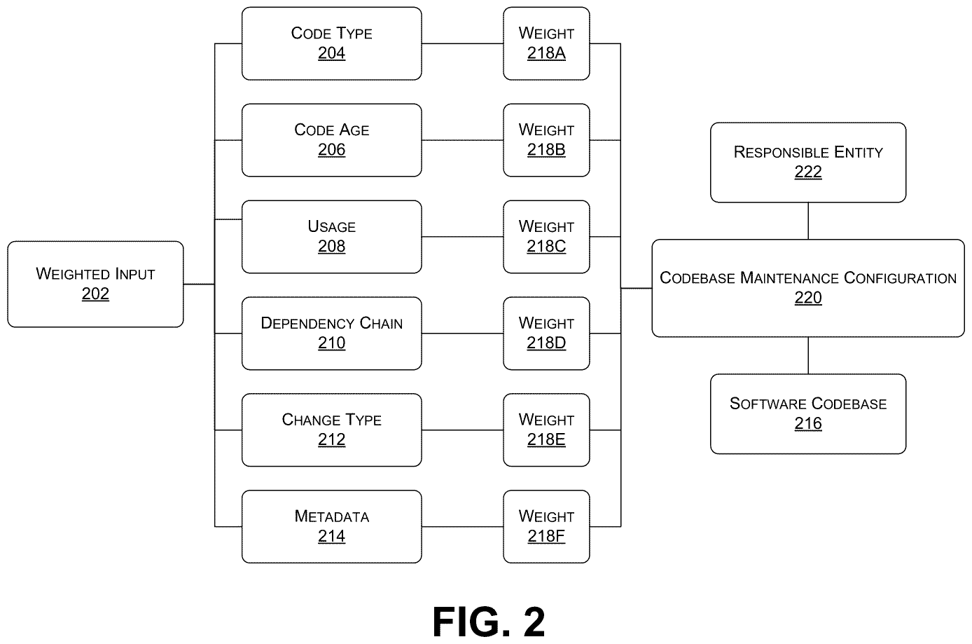

Turning now to FIG. 2, aspects of an example weighted input 202 are shown and described. As mentioned above with respect to FIG. 1, a weighted input 108 includes a plurality of factors 112A-112N that describe various properties of an associated software codebase 104. Likewise, the weighted input 202 of the present example includes six factors describing a code type 204, a code age 206, a usage 208, a dependency chain 210, a change type 212, and metadata 214 of an associated software codebase 216. In addition, each of the factors 204-214 is assigned a corresponding weight 218A-218F that emphasizes or deemphasizes the associated factor 204-214. The inclusion of each of the factors 204-214 as well as the specific weights 218A-218F assigned to each are defined by a codebase maintenance configuration 220 that is customizable by a responsible entity 222 of the software codebase 216. It should be understood that while specific factors 204-214 are discussed with respect to FIG. 2, any number and type of factors can be included in the weighted input 202 to accurately describe the software codebase 216.

With respect to the example illustrated in FIG. 2, the code type 204 factor describes the type of code that the software codebase 216 contains. In one example, the code type 204 is application source code comprising the instructions that are compiled into an executable application (e.g., a cloud computing service). In another example, the code type 204 is service infrastructure code that supports the function of the application. In still another example, the code type 204 is client code that is developed and deployed by a user of the cloud computing platform as opposed to the operator of the platform. Other examples of code types 104 include front-end code, back-end code, server code, and open-source code. In various examples, the code type 204 is encoded as a numerical value (e.g., binary, hexadecimal) to enable compatibility with the corresponding weight 218A as some code types may be more readily deprecated than others. For instance, depending on the application supported by the software codebase 216, deprecating source code may be unnecessary and/or pose an undue risk of failures whereas deprecating front-end code is often a routine process (e.g., when rebranding a website).

The code age 206 factor describes the physical age of the software codebase 216 (e.g., three months, ten years). Intuitively, the older a given software codebase 216 is, the more likely that code therein is outdated and thus eligible for deprecation. However, there is nuance in this determination as not all old software codebases 216 should be deprecated nor should all new software codebases 216 be left alone. For example, a cloud platform operator that has been providing service for an extended time (e.g., years) may continue to support clients using on-premises (e.g., “on-prem”) computing infrastructure. As such, a software codebase 216 relating to the on-premises infrastructure may be many years old but nonetheless necessary to maintain service quality. Conversely, an error in a newly deployed software codebase 216 may be causing a degradation in service quality thereby justifying deprecation.

The usage 208 factor describes a volume of usage based on the frequency of accesses to the software codebase 216 (e.g., API calls). As such, a software codebase 216 with higher usage poses a greater risk in the event of deprecation in relation to a different codebase with very low usage. Moreover, some of the factors 204-214 may override other factors. For instance, a software codebase 216 with a very high code age (e.g., decades) may also have very high usage 208 indicating that at least some of the software codebase 216 is integral to other components of the platform. As such, the deprecation system can determine that software codebase 216 should not be deprecated in light of the usage factor 208 despite the advanced code age 206.

In a similar fashion, the dependency chain 210 factor describes the extent to which other software codebases depend on the software codebase 216 and/or the extent to which the software codebase 216 depends on other software codebases. Consequently, the analysis agent 102 can analyze the dependency chain 210 and determine that a software codebase 216 that is depended on by many other software codebases should not be deprecated and/or cannot be safely deprecated. Conversely, the analysis agent 102 can determine that a software codebase 216 with very few dependencies in either direction can be safely deprecated.

The change type 212 factor describes the type of change that needs to be deployed in order to remove the software codebase 216 from active usage in the event of deprecation. As mentioned above, a software codebase 216 for application source code may require a different deprecation process in relation to another software codebase for service infrastructure code. Consequently, different change types 212 may entail different considerations for deployment that each carry different technical risks. For instance, deploying a change to remove a deployment infrastructure software codebase 216 (e.g., “flighting”) can pose a significant risk in a cloud computing context wherein perpetual uptime is important. Conversely, deploying a change to remove a portion of a front-end software codebase 216 for a website may involve, comparatively, much less risk.

Finally, the metadata 214 factor includes any higher-order information (e.g., besides code) relating to the software codebase 216 such as the responsible entity 222, changelogs, deployment history, permissions, relevant licenses, and so forth. The metadata 214 can provide insight on past behaviors of the associated software codebase 216 that can impact the decision whether to deprecate the software codebase 216. For instance, a software codebase 216 with a higher propensity for errors is a more eligible candidate for deprecation in relation to a relatively error-free codebase. In another example, the metadata 214 can describe the application space of the software codebase 216 (e.g., healthcare, defense, commercial, personal use). Consequently, deprecating a software codebase 216 that belongs to a commercial airline poses a significantly greater risk in relation to deprecating a personal software codebase 216 belonging to a hobbyist coder. Moreover, deprecating software codebases 216 in different application spaces accordingly involves different considerations with respect to various rules and regulations such as data retention policies. For instance, a software codebase 216 for managing and accessing tax data is subject to strict data retention policies that a software codebase for application source code is not. While specific examples of factors 204-214 have been described herein, it should be understood that the weighted input 202 can be configured to include any number and/or type of other factors.

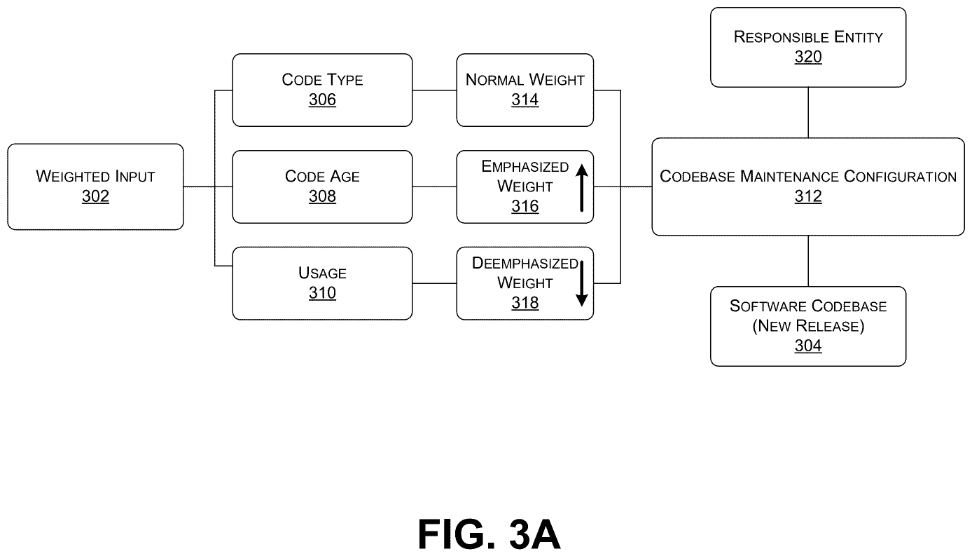

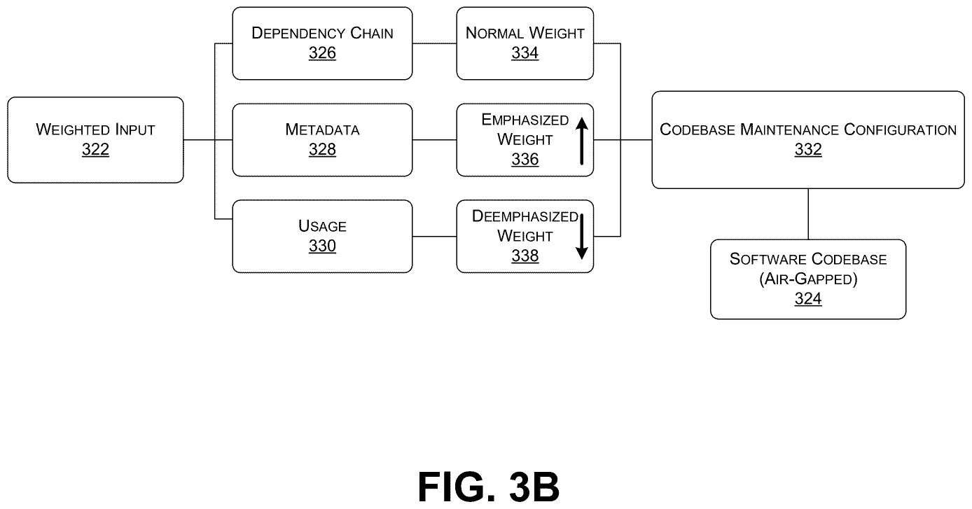

Turning now to FIG. 3A, an example of adjusting a weighted input 302 based on the operation context of an associated software codebase 304 is shown and described. With respect to FIG. 3A, consider a weighted input 302 that represents a code type 306 factor, a code age 308 factor, and a usage 310 factor. However, it should be understood that the weighted input 302 can include other factors not illustrated herein. In the present example, the software codebase 304 has been newly deployed (e.g., within the last two weeks), and thus, is labeled as a “new release” software codebase 304 in FIG. 3A. As such, it is most likely that the software codebase 304 does not see a significant amount of usage (e.g., from users, from other codebases). Accordingly, the low age and usage of the software codebase 304 is recorded in the code age 308 factor and the usage 310 factor respectively.

As mentioned above, the various factors 306-310 of the weighted input 302 can have a weighting applied to emphasize and/or deemphasize specific factors. Accordingly, the codebase maintenance configuration 312 can define which factors 306-310 are included in the weighted input 302 as well as the weights 314-318 applied to each of the factors 306-310. In the present example, the code type 306 factor receives a normal weight 314 indicating that the code type 306 factor is not emphasized or deemphasized in the weighted input 302. Meanwhile, the codebase maintenance configuration 312 applies an emphasized weight 316 to the code age 308 factor thereby increasing the influence of the code age 308 factor in the weighted input 302. Conversely, the codebase maintenance configuration 312 applies a deemphasized weight 318 to the usage 310 factor to decrease the influence of the usage 310 factor on the weighted input 302. Stated another way, the codebase maintenance configuration 312 causes the analysis agent 102 to defer to certain factors when calculating a deprecation score 116 as described above with respect to FIG. 1 by applying different weights 316 and 318 to corresponding factors 308 and 310 respectively.

In this way, the codebase maintenance configuration 312 modifies the weighted input 302 to accurately reflect the operational context of the newly released software codebase 304. That is, a weighted input 302 representing a software codebase 304 with a low code age 308 and correspondingly low usage 310 is weighted to prevent the software codebase 304 from being deprecated for being unused despite the newness of the software codebase 304. In various examples, the magnitude of the emphasized weight 316 and/or the deemphasized weight 318 can also be customized by the codebase maintenance configuration 312. That is, for two factors that are both assigned emphasized weights, one factor may be more heavily emphasized than the other. More generally, the codebase maintenance configuration 312 enables a responsible entity 320 of the software codebase 304 to customize the factors 306-310 and weights 314-318 of the weighted input 302 as needed based on the operational context of the software codebase 304.

Turning now to FIG. 3B, another example of adjusting a weighted input 322 based on the operation context of an associated software codebase 324 is shown and described. Similar to the example discussed above, the weighted input 322 represents a dependency chain 326 factor, a metadata 328 factor, and a usage 330 factor. As mentioned above, the dependency chain 326 factor describes the extent to which other software codebases depend on the software codebase 324 and/or the extent to which the software codebase 324 depends on other software codebases. Moreover, the metadata 328 factor includes any higher-order information (e.g., besides code) relating to the software codebase 324 such as the responsible entity, changelogs, deployment history, permissions, relevant licenses, and so forth.

In the present example, consider a software codebase 324 that is deployed in an “air-gapped” network. That is, the software codebase 324 is deployed in a secure computer network that is physically isolated from unsecured network such as the internet. As such, the deprecation system described above can be deployed in this isolated context to perform automated deprecation to maintain code quality and security. Accordingly, a codebase maintenance configuration 332 defines various weights 334-338 to adjust the weighted input 322 to the operational context of an air-gapped network.

As shown, the dependency chain 326 factor is assigned a normal weight 334 meaning that the dependency chain 326 factor is not emphasized or deemphasized in the weighted input 322. Meanwhile, the codebase maintenance configuration 332 assigns an emphasized weight 336 to the metadata 328 factor to increase its influence on the weighted input 322. Conversely, the codebase maintenance configuration 332 assigns a deemphasized weight 338 to the usage 330 factor to decrease its influence on the weighted input 322. As mentioned above, the software codebase 324 is deployed in an air-gapped network meaning that access to the software codebase 324 is heavily controlled and thus very limited. Consequently, usage metrics for the software codebase 324, captured by the usage 330 factor, would indicate that the software codebase 324 sees very little usage and is thus a likely candidate for deprecation. However, deemphasizing the usage factor 330 using the deemphasized weight 338 reflects the reality that the software codebase 324 is designed to see very little usage.

Likewise, metadata for the software codebase 324, represented by the metadata 328 factor, can indicate that the software codebase 324 is deployed in an isolated and secured network thereby increasing the risk posed in the event of deprecation. Moreover, the metadata 328 factor can indicate that the software codebase 324 experiences very few errors. That is, the software codebase 324 is not prone to errors and/or failures. As such, applying an emphasized weight to the metadata 328 factor elevates the context provided by the metadata regarding the operational context of the software codebase 324.

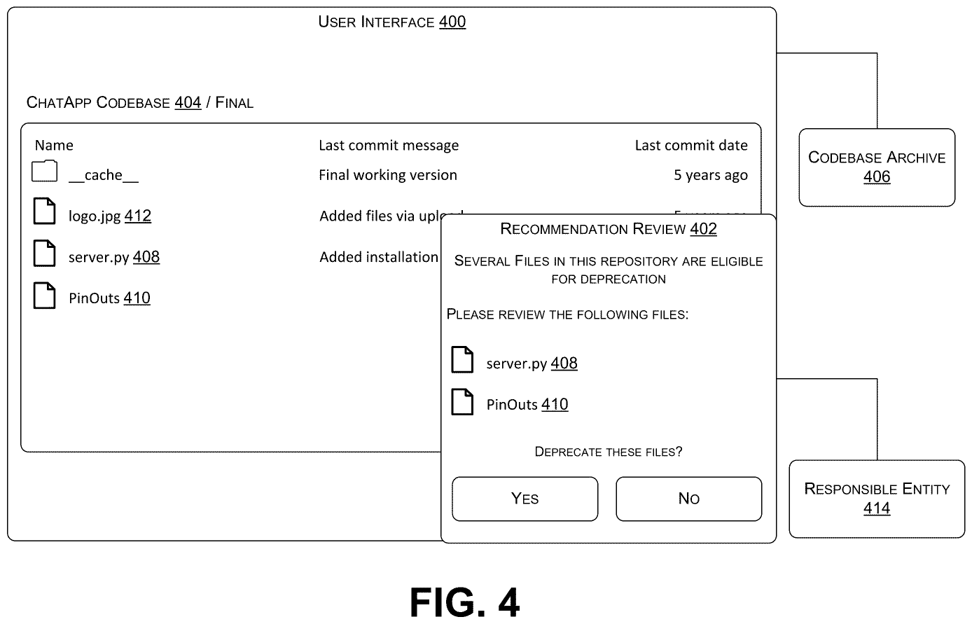

Proceeding now to FIG. 4, aspects of a user interface 400 for viewing and/or approving a recommendation review 402 for deprecating a software codebase 404 are shown and described. As mentioned above, after storing the software codebase 404 in a codebase archive 406 for a predefined time period (e.g., six months), the deprecation system can proceed to a final removal (e.g., deletion) of the software codebase 404. As shown in FIG. 4, the recommendation review 402 lists specific files that are eligible for deprecation including a “server.py” file 408 and a “PinOuts” file 410.

In various examples, deprecating a software codebase 404 can involve deleting some or all of the files contained therein. That is, a software codebase 404 can be deprecated without necessarily removing all of the associated files. In the present example, the software codebase 404 is deprecated by removing the “server.py” file 408 and a “PinOuts” file 410 while leaving a “logo.jpg” file 412. Accordingly, the recommendation review 402 is provided to a responsible entity 414 of the software codebase 404 (e.g., an engineer, a team, an automated tool) for approval. Upon approving the recommendation review 402, the list files 408 and 410 are permanently deleted from the repository storing the software codebase 404. In this way, the recommendation review 402 enables the responsible entity 414 to bring specific knowledge to the deprecation process and prevent improper deprecations. Moreover, the input from the responsible entity 414 to various recommendation reviews 402 can be utilized by the deprecation system to further train the analysis agent thereby improving automated deprecation operations over time.

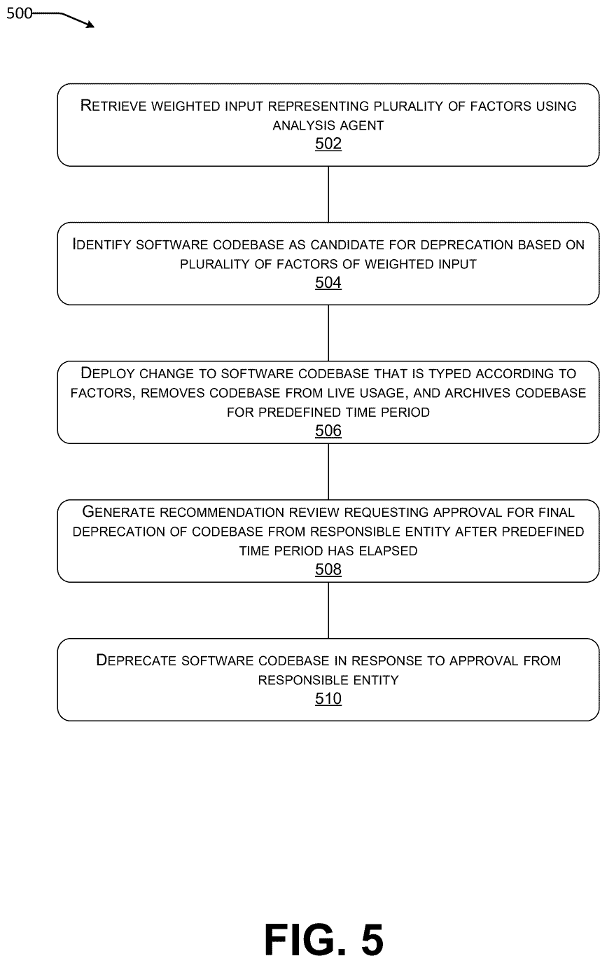

Turning now to FIG. 5, aspects of a process 500 for automated software codebase deprecation are shown and described. With respect to FIG. 5, the process 500 begins at operation 502 in which a deprecation system retrieves a weighted input that is associated with a software codebase. As described above, the weighted input represents a plurality of factors describing various aspects of the software codebase. Examples of the factors include code type (e.g., source code, open-source code, config files, infrastructure code), code age, usage (e.g., volume of API calls), dependencies of the software codebase, metadata, and error history. Accordingly, the weighted input is retrieved by a self-training analysis agent. In various examples, the analysis agent is a computational model implementing an artificial intelligence such as a language model that is configured to identify software codebases for deprecation based on associated weighted inputs. As such, the analysis agent is initially trained on a training dataset prior to deployment in the deprecation system. Moreover, the analysis agent can continue to learn during deployment based on the various software codebases and associated weighted inputs it encounters during normal operation.

Next, at operation 504, the deprecation system identifies the software codebase as a candidate for deprecation based on the plurality of factors of the weighted input. As mentioned above, this identification can be derived from calculating a deprecation score that quantifies the risk of deprecating the software codebase. In various examples, a higher deprecation score can indicate a higher risk. As such, the analysis agent can be configured with a threshold deprecation score that defines a maximum acceptable risk when deprecating a software codebase. Consequently, if the deprecation score for a given software codebase is less than or equal to the threshold deprecations score, the software codebase can be identified as a candidate for deprecation.

Then, at operation 506, the deprecation system deploys a change to the software codebase to begin the deprecation process. In various examples, the type of the change can be determined based on the factors of the weighted input. For instance, a software codebase for source code may require a different change in relation to a software codebase for configuration files. Accordingly, the change removes the software codebase from active usage (e.g., it is no longer publicly accessible) and archives the software codebase for a predefined time period. In this way, archiving the software codebase prior to final deprecation enables the deprecation system to (1) revive archived codebases if needed (e.g., to address an unexpected error) and (2) comply with data retention policies and/or regulations.

Proceeding to operation 508, following the predefined time period, the deprecation system generates a recommendation review to request approval for final deprecation of the software codebase from a responsible entity in charge of the software codebase (e.g., an engineer, an engineering team, an automated tool). As mentioned above, the recommendation review can specify specific files that are to be deprecated and instruct the responsible entity to review the relevant files before providing approval.

Finally, at operation 510, in response to the approval of the recommendation review from the responsible entity, the deprecation system performs final deprecation of the software codebase. In various examples, final deprecation involves fully deleting the software codebase from the infrastructure system that manages the software codebase (e.g., a cloud service).

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated method can begin and/or end at any time and need not be performed in its entirety. Some or all operations of the method, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 500 can be implemented, at least in part, by modules running the features disclosed herein can be a dynamically linked library, a statically linked library, functionality produced by an application programing interface, a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 500 may also be implemented in other ways. In addition, one or more of the operations of the process 500 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

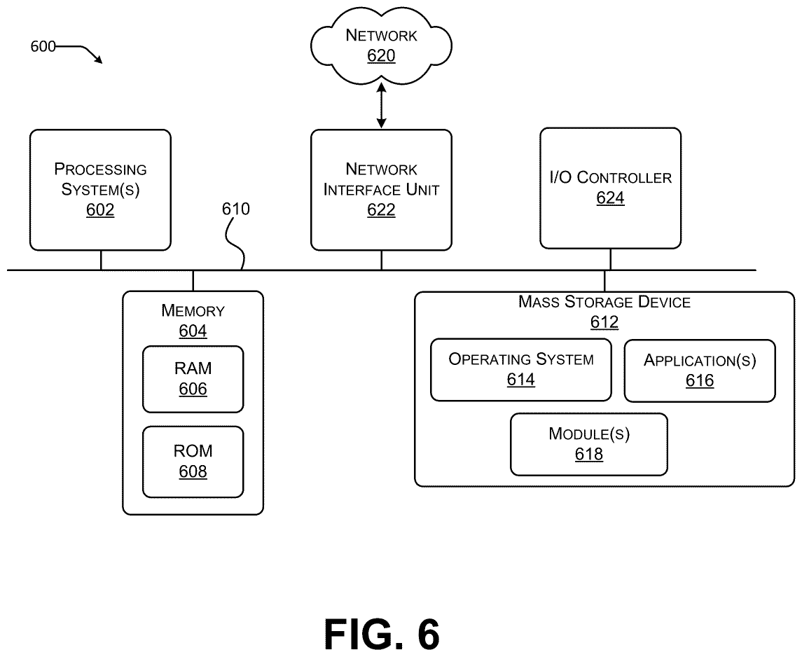

FIG. 6 shows additional details of an example computer architecture 600 for a device, capable of executing computer instructions (e.g., a module or a program component described herein). The computer architecture 600 illustrated in FIG. 6 includes processing system 602, a system memory 604, including a random-access memory 606 (RAM) and a read-only memory (ROM) 608, and a system bus 610 that couples the memory 604 to the processing system 602. The processing system 602 comprises processing unit(s). In various examples, the processing unit(s) of the processing system 602 are distributed. Stated another way, one processing unit of the processing system 602 may be located in a first location (e.g., a rack within a datacenter) while another processing unit of the processing system 602 is located in a second location separate from the first location. Moreover, the systems discussed herein can be provided as a distributed computing system such as a cloud service.

Processing unit(s), such as processing unit(s) of processing system 602, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 600, such as during startup, is stored in the ROM 608. The computer architecture 600 further includes a mass storage device 612 for storing an operating system 614, application(s) 616, modules 618, and other data described herein.

The mass storage device 612 is connected to processing system 602 through a mass storage controller connected to the bus 610. The mass storage device 612 and its associated computer-readable media provide non-volatile storage for the computer architecture 600. Although the description of computer-readable media contained herein refers to a mass storage device, the computer-readable media can be any available computer-readable storage media or communication media that can be accessed by the computer architecture 600.

Computer-readable media includes computer-readable storage media and/or communication media. Computer-readable storage media includes one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 600 may operate in a networked environment using logical connections to remote computers through the network 620. The computer architecture 600 may connect to the network 620 through a network interface unit 622 connected to the bus 610. The computer architecture 600 also may include an input/output controller 624 for receiving and processing input from a number of other devices, including a keyboard, mouse, touch, or electronic stylus or pen. Similarly, the input/output controller 624 may provide output to a display screen, a printer, or other type of output device.

The software components described herein may, when loaded into the processing system 602 and executed, transform the processing system 602 and the overall computer architecture 600 from a general-purpose computing system into a special-purpose computing system customized to facilitate the functionality presented herein. The processing system 602 may be constructed from any number of transistors or other discrete circuit elements, which may individually or collectively assume any number of states. More specifically, the processing system 602 may operate as a finite-state machine, in response to executable instructions contained within the software modules disclosed herein. These computer-executable instructions may transform the processing system 602 by specifying how the processing system 602 transition between states, thereby transforming the transistors or other discrete hardware elements constituting the processing system 602.

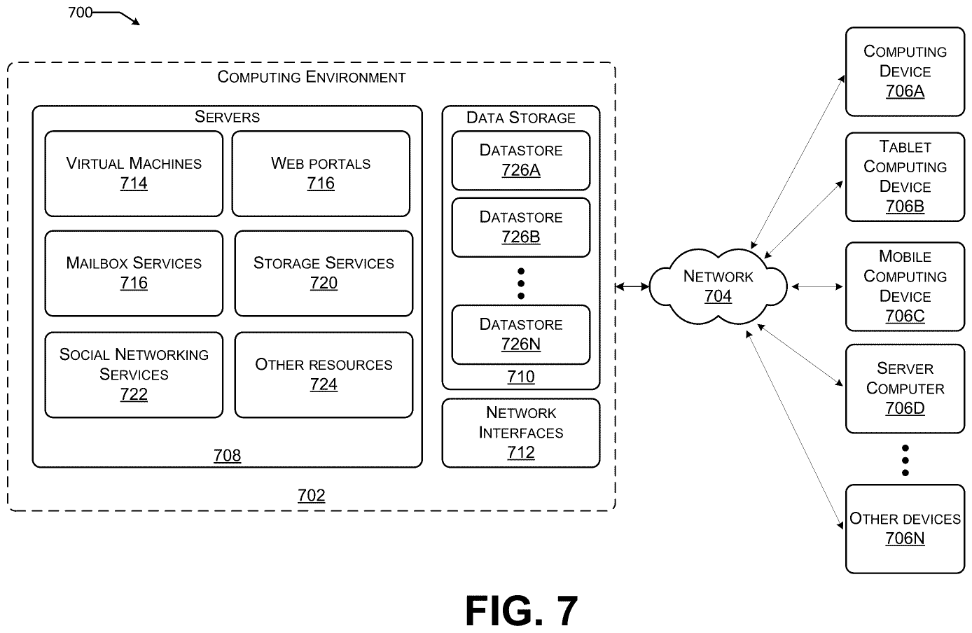

FIG. 7 depicts an illustrative distributed computing environment 700 capable of executing the software components described herein to enable automated software codebase deprecation within a networked computing environment. Thus, the distributed computing environment 700 illustrated in FIG. 7 can be utilized to execute any aspects of the software components presented herein. Various examples include, the computational model implementing the analysis agent, the infrastructure system managing the software codebase, cloud computing services that are supported by the software codebase, and so forth.

Accordingly, the distributed computing environment 700 can include a computing environment 702 operating on, in communication with, or as part of the network 704. The network 704 can include various access networks. One or more client devices 706A-706N (hereinafter referred to collectively and/or generically as “computing devices 706”) can communicate with the computing environment 702 via the network 704. In one illustrated configuration, the computing devices 706 include a computing device 706A such as a laptop computer, a desktop computer, or other computing device; a slate or tablet computing device (“tablet computing device”) 706B; a mobile computing device 706C such as a mobile telephone, a smart phone, or other mobile computing device; a server computer 706D; and/or other devices 706N. It should be understood that any number of computing devices 706 can communicate with the computing environment 702.

In various examples, the computing environment 702 includes servers 708, data storage 710, and one or more network interfaces 712. The servers 708 can host various services, virtual machines, portals, and/or other resources. In the illustrated configuration, the servers 708 host virtual machines 714, Web portals 716, mailbox services 718, storage services 720, and/or social networking services 722. As shown in FIG. 7 the servers 708 also can host other services, applications, portals, and/or other resources (“other resources”) 724.

As mentioned above, the computing environment 702 can include the data storage 710. According to various implementations, the functionality of the data storage 710 is provided by one or more databases operating on, or in communication with, the network 704. The functionality of the data storage 710 also can be provided by one or more servers configured to host data for the computing environment 700. The data storage 710 can include, host, or provide one or more real or virtual datastores 726A-726N (hereinafter referred to collectively and/or generically as “datastores 726”). The datastores 726 are configured to host data used or created by the servers 808 and/or other data. That is, the datastores 726 also can host or store web page documents, word documents, presentation documents, data structures, algorithms for execution by a recommendation engine, and/or other data utilized by any application program. Aspects of the datastores 726 may be associated with a service for storing files.

The computing environment 702 can communicate with, or be accessed by, the network interfaces 712. The network interfaces 712 can include various types of network hardware and software for supporting communications between two or more computing devices including the computing devices and the servers. It should be appreciated that the network interfaces 712 also may be utilized to connect to other types of networks and/or computer systems.

It should be understood that the distributed computing environment 700 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 700 provides the software functionality described herein as a service to the computing devices. It should be understood that the computing devices can include real or virtual machines including server computers, web servers, personal computers, mobile computing devices, smart phones, and/or other devices. As such, various configurations of the concepts and technologies disclosed herein enable any device configured to access the distributed computing environment 700 to utilize the functionality described herein for providing the techniques disclosed herein, among other aspects.

The disclosure presented herein also encompasses the subject matter set forth in the following clauses.
Example Clause A, a method for automated deprecation of a software codebase utilizing a computational model to analyze a weighted input representing a plurality of factors describing the software codebase wherein each individual factor is weighted according to an operational context of the software codebase, the method comprising: retrieving the weighted input representing the plurality of factors including at least a code type of the software codebase, a code age of the software codebase, and a usage of the software codebase in response to an activation signal, wherein each individual factor of the plurality of factors is weighted according to the operational context of the software codebase; identifying the software codebase as a candidate for deprecation based on the plurality of factors of the weighted input; deploying a change to the software codebase in response to an approval of the change from a responsible entity of the software codebase, wherein: a change type of the change is configured based on the plurality of factors of the weighted input; the change removes the software codebase from active usage; and the change archives the software codebase for a predefined time period; in response to determining that the predetermined time period has elapsed, generating a recommendation review for the responsible entity of the software codebase, the recommendation review requesting a deprecation of the software codebase; and deprecating the software codebase in response to an approval of the recommendation review from the responsible entity.
Example Clause B, the method of Example Clause A, wherein: the weighted input is a first weighted input; and the software codebase is a first software codebase, the method further comprising: retrieving a second weighted input representing a second software codebase, wherein the first software codebase and the second software codebase are managed by a same infrastructure system; and applying, by the computational model, a first weighting to the first weighted input and a second weighting to the second weighted input.
Example Clause C, the method of Example Clause A or Example Clause B, wherein the plurality of factors further includes at least one of a dependency chain of the software codebase, metadata describing one or more aspects of the software codebase, or an error history of the software codebase.
Example Clause D, the method of any one of Example Clause A through C, wherein the activation signal is a manual trigger for causing the computational model to retrieve the weighted input.
Example Clause E, the method of any one of Example Clause A through C, wherein the activation signal is an automated trigger for causing the computational model to retrieve the weighted input in response to at least one of a regular time interval or an automated alert.
Example Clause F, the method of any one of Example Clause A through E, wherein the computational model is a self-training model that is configured to iteratively adjust the weighted input based on the plurality of factors and metrics derived from the software codebase.
Example Clause G, the method of any one of Example Clause A through F, wherein: the software codebase is a first software codebase; the first software codebase is managed by a first infrastructure system; the computational model is integrated into the first infrastructure system and a second infrastructure system that manages a second software codebase; and the computational model is configured to apply a first weighting to the first infrastructure system and a second weighting to the second infrastructure system.
Example Clause H, a system for automated deprecation of a software codebase utilizing a computational model to analyze a weighted input representing a plurality of factors describing the software codebase wherein each individual factor is weighted according to an operational context of the software codebase, the system comprising: a processing system; a computer-readable medium having encoded thereon, computer-readable instructions that, when executed by the processing system, cause the system to perform operations comprising: retrieving the weighted input representing the plurality of factors in response to an activation signal, wherein each individual factor of the plurality of factors is weighted according to the operational context of the software codebase; identifying the software codebase as a candidate for deprecation based on the plurality of factors of the weighted input; deploying a change to the software codebase wherein: a change type of the change is configured based on the plurality of factors of the weighted input; the change removes the software codebase from active usage; and the change archives the software codebase for a predefined time period; in response to determining that the predetermined time period has elapsed, generating a recommendation review for a responsible entity of the software codebase, the recommendation review requesting a deprecation of the software codebase; and deprecating the software codebase in response to an approval of the recommendation review from the responsible entity.
Example Clause I, the system of Example Clause H, wherein: the weighted input is a first weighted input; and the software codebase is a first software codebase, the method further comprising: retrieving a second weighted input representing a second software codebase, wherein the first software codebase and the second software codebase are managed by a same infrastructure system; and applying, by the computational model, a first weighting to the first weighted input and a second weighting to the second weighted input.
Example Clause J, the system of Example Clause H or Example Clause I, wherein the plurality of factors includes at least two of a code type of the software codebase, a code age of the software codebase, a usage of the software codebase, dependency chain of the software codebase, metadata describing one or more aspects of the software codebase, or an error history of the software codebase.
Example Clause K, the system of any one of Example Clause H through J, wherein the activation signal is a manual trigger for causing the computational model to retrieve the weighted input.
Example Clause L, the system of any one of Example Clause H through J, wherein the activation signal is an automated trigger for causing the computational model to retrieve the weighted input in response to at least one of a regular time interval or an automated alert.
Example Clause M, the system of any one of Example Clause H through L, wherein the computational model is a self-training model that is configured to iteratively adjust the weighted input based on the plurality of factors and metrics derived from the software codebase.
Example Clause N, the system of any one of Example Clause H through M, wherein: the software codebase is a first software codebase; the first software codebase is managed by a first infrastructure system; the computational model is integrated into the first infrastructure system and a second infrastructure system that manages a second software codebase; and the computational model is configured to apply a first weighting to the first infrastructure system and a second weighting to the second infrastructure system.
Example Clause O, a system for automated deprecation of a software codebase utilizing an computational model to analyze a weighted input representing a plurality of factors describing the software codebase wherein each individual factor is weighted according to an operational context of the software codebase, the system comprising: a processing system; a computer-readable storage medium having encoded thereon, computer-readable instructions that, when executed by the processing system, cause the system to perform operations comprising: retrieving the weighted input representing the plurality of factors in response to an activation signal, wherein each individual factor of the plurality of factors is weighted according to the operational context of the software codebase; identifying the software codebase as a candidate for deprecation based on the plurality of factors of the weighted input; deploying a change to the software codebase wherein: a change type of the change is configured based on the plurality of factors of the weighted input; the change removes the software codebase from active usage; and the change archives the software codebase for a predefined time period; and reviving the software codebase in response to a codebase revival request from a responsible entity of the software codebase, wherein reviving the software codebase restores the software codebase to active usage.
Example Clause P, the system of Example Clause O, wherein the plurality of factors includes at least two of a code type of the software codebase, a code age of the software codebase, a usage of the software codebase, dependency chain of the software codebase, metadata describing one or more aspects of the software codebase, or an error history of the software codebase.
Example Clause Q, the system of Example Clause O or Example Clause P, the computational model is a self-training model that is configured to iteratively adjust the weighted input based on the plurality of factors and metrics derived from the software codebase.
Example Clause R, the system of any one of Example Clause O through Q, wherein: the software codebase is a first software codebase; the first software codebase is managed by a first infrastructure system; the computational model is integrated into the first infrastructure system and a second infrastructure system that manages a second software codebase; and the computational model is configured to apply a first weighting to the first infrastructure system and a second weighting to the second infrastructure system.
Example Clause S, the system of any one of Example Clause O through R, wherein the activation signal is an automated trigger for causing the computational model to retrieve the weighted input in response to at least one of a regular time interval or an automated alert.
Example Clause T, the system of any one of Example Clause O through R, wherein the activation signal is a manual trigger for causing the computational model to retrieve the weighted input.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for automated deprecation of a software codebase utilizing a computational model to analyze a weighted input representing a plurality of factors describing the software codebase wherein each individual factor is weighted according to an operational context of the software codebase, the method comprising:
retrieving the weighted input representing the plurality of factors including at least a code type of the software codebase, a code age of the software codebase, and a usage of the software codebase in response to an activation signal, wherein each individual factor of the plurality of factors is weighted according to the operational context of the software codebase;
identifying the software codebase as a candidate for deprecation based on the plurality of factors of the weighted input;
deploying a change to the software codebase in response to an approval of the change from a responsible entity of the software codebase, wherein:
a change type of the change is configured based on the plurality of factors of the weighted input;
the change removes the software codebase from active usage; and
the change archives the software codebase for a predefined time period;
in response to determining that the predetermined time period has elapsed, generating a recommendation review for the responsible entity of the software codebase, the recommendation review requesting a deprecation of the software codebase; and
deprecating the software codebase in response to an approval of the recommendation review from the responsible entity.

2. The method of claim 1, wherein:
the weighted input is a first weighted input; and
the software codebase is a first software codebase, the method further comprising:
retrieving a second weighted input representing a second software codebase, wherein the first software codebase and the second software codebase are managed by a same infrastructure system; and
applying, by the computational model, a first weighting to the first weighted input and a second weighting to the second weighted input.

3. The method of claim 1, wherein the plurality of factors further includes at least one of a dependency chain of the software codebase, metadata describing one or more aspects of the software codebase, or an error history of the software codebase.

4. The method of claim 1, wherein the activation signal is a manual trigger for causing the computational model to retrieve the weighted input.

5. The method of claim 1, wherein the activation signal is an automated trigger for causing the computational model to retrieve the weighted input in response to at least one of a regular time interval or an automated alert.

6. The method of claim 1, wherein the computational model is a self-training model that is configured to iteratively adjust the weighted input based on the plurality of factors and metrics derived from the software codebase.

7. The method of claim 1, wherein:
the software codebase is a first software codebase;
the first software codebase is managed by a first infrastructure system;
the computational model is integrated into the first infrastructure system and a second infrastructure system that manages a second software codebase; and
the computational model is configured to apply a first weighting to the first infrastructure system and a second weighting to the second infrastructure system.

8. A system for automated deprecation of a software codebase utilizing a computational model to analyze a weighted input representing a plurality of factors describing the software codebase wherein each individual factor is weighted according to an operational context of the software codebase, the system comprising:
a processing system;
a computer-readable medium having encoded thereon, computer-readable instructions that, when executed by the processing system, cause the system to perform operations comprising:
retrieving the weighted input representing the plurality of factors in response to an activation signal, wherein each individual factor of the plurality of factors is weighted according to the operational context of the software codebase;
identifying the software codebase as a candidate for deprecation based on the plurality of factors of the weighted input;
deploying a change to the software codebase wherein:
a change type of the change is configured based on the plurality of factors of the weighted input;
the change removes the software codebase from active usage; and
the change archives the software codebase for a predefined time period;
in response to determining that the predetermined time period has elapsed, generating a recommendation review for a responsible entity of the software codebase, the recommendation review requesting a deprecation of the software codebase; and
deprecating the software codebase in response to an approval of the recommendation review from the responsible entity.

9. The system of claim 8, wherein:
the weighted input is a first weighted input; and
the software codebase is a first software codebase, the method further comprising:
retrieving a second weighted input representing a second software codebase, wherein the first software codebase and the second software codebase are managed by a same infrastructure system; and
applying, by the computational model, a first weighting to the first weighted input and a second weighting to the second weighted input.

10. The system of claim 8, wherein the plurality of factors includes at least two of a code type of the software codebase, a code age of the software codebase, a usage of the software codebase, dependency chain of the software codebase, metadata describing one or more aspects of the software codebase, or an error history of the software codebase.

11. The system of claim 8, wherein the activation signal is a manual trigger for causing the computational model to retrieve the weighted input.

12. The system of claim 8, wherein the activation signal is an automated trigger for causing the computational model to retrieve the weighted input in response to at least one of a regular time interval or an automated alert.

13. The system of claim 8, wherein the computational model is a self-training model that is configured to iteratively adjust the weighted input based on the plurality of factors and metrics derived from the software codebase.

14. The system of claim 8, wherein:
the software codebase is a first software codebase;
the first software codebase is managed by a first infrastructure system;
the computational model is integrated into the first infrastructure system and a second infrastructure system that manages a second software codebase; and
the computational model is configured to apply a first weighting to the first infrastructure system and a second weighting to the second infrastructure system.

15. A system for automated deprecation of a software codebase utilizing an computational model to analyze a weighted input representing a plurality of factors describing the software codebase wherein each individual factor is weighted according to an operational context of the software codebase, the system comprising:
a processing system;
a computer-readable storage medium having encoded thereon, computer-readable instructions that, when executed by the processing system, cause the system to perform operations comprising:
retrieving the weighted input representing the plurality of factors in response to an activation signal, wherein each individual factor of the plurality of factors is weighted according to the operational context of the software codebase;
identifying the software codebase as a candidate for deprecation based on the plurality of factors of the weighted input;
deploying a change to the software codebase wherein:
a change type of the change is configured based on the plurality of factors of the weighted input;
the change removes the software codebase from active usage; and
the change archives the software codebase for a predefined time period; and
reviving the software codebase in response to a codebase revival request from a responsible entity of the software codebase, wherein reviving the software codebase restores the software codebase to active usage.

16. The system of claim 15, wherein the plurality of factors includes at least two of a code type of the software codebase, a code age of the software codebase, a usage of the software codebase, dependency chain of the software codebase, metadata describing one or more aspects of the software codebase, or an error history of the software codebase.

17. The system of claim 15, the computational model is a self-training model that is configured to iteratively adjust the weighted input based on the plurality of factors and metrics derived from the software codebase.

18. The system of claim 15, wherein:
the software codebase is a first software codebase;
the first software codebase is managed by a first infrastructure system;
the computational model is integrated into the first infrastructure system and a second infrastructure system that manages a second software codebase; and
the computational model is configured to apply a first weighting to the first infrastructure system and a second weighting to the second infrastructure system.

19. The system of claim 15, wherein the activation signal is an automated trigger for causing the computational model to retrieve the weighted input in response to at least one of a regular time interval or an automated alert.

20. The system of claim 15, wherein the activation signal is a manual trigger for causing the computational model to retrieve the weighted input.
